(19) United States
(12) Patent Application Publication
(10) Pub. No.: US 2010/0128031 A1
(43) Pub. Date: May 27, 2010

(54) CHAT TERMINAL DEVICE AND CHAT SYSTEM

(75) Inventors: Hirotaka Uoi, Osaka (JP); Takahito Kazama, Osaka (JP)

Correspondence Address: FOLEY & LARDNER LLP, 150 EAST GILMAN STREET, P.O. BOX 1497, MADISON, WI, 53701-1497, US

(73) Assignee: OSAKA ELECTRO-COMMUNICATION UNIVERSITY, Osaka (JP)

(21) Appl. No.: 12/440,202

(22) PCT Filed: Sep. 7, 2006
(86) PCT No.: PCT/JP2006/317724

§ 371 Date: Dec. 31, 2009

(51) Int. Cl. G09G 5/00; G06F 3/048; G06T 15/00

(52) U.S. Cl. 345/419; 715/758; 345/672

(57) ABSTRACT

A terminal device including a module that receives from a chat sever chat data including comment sentence text data and positional information on an object placed on a chat canvas and stores it in a memory, a module that projects an object placed on the chat canvas to a screen viewed from a virtual camera in a three-dimensional virtual space and calculates the position of the object on the screen, a module that displays on the chat window the comment sentence text data corresponding to the object on the basis of the position of the object on the screen, the position, line-of-sight direction or camera parameter of the virtual camera in the three-dimensional virtual space is changed on the basis of an input from a user.

### TECHNICAL FIELD

The present invention relates to a chat system that enable users to makes text-based conversions in real time over a computer network, and it particularly relates to a chat terminal device used in the chat system.

### BACKGROUND ART

Hitherto, a chat system has been known that enable users to make text-based conversations in real time over a computer network (refer to Patent Document 1). In the conventional chat system, a chat room is generally prepared for each topic, and, in each chat room, a list of comment sentences input by chat participants is displayed from the top to the bottom of a chat window in order of input (that is, along a one-dimensional time axis).

On the other hand, in recent years, a chat system allowing the placement of a comment sentence at a free position in a predetermined two-dimensional area (chat canvas) (which will be called “two-dimensional chat system” hereinafter) has been proposed/developed (refer to Non-Patent Document 1). In such a two-dimensional chat system, by differentiating the placed positions of comment sentences among topics on a chat canvas, they can be visually grouped.

Therefore, it is suitable for the simultaneous development of discussions on multiple topics on one chat canvas.

[Patent Document 1] Japanese Unexamined Patent Application Publication No. 2002-288102

[Non-Patent Document 1] Makoto FUKUI and Hirotaka UOI, “Nijigen Chat System no Kaiwa no Nagare wo Haakusuru Syuhou ni Kansuru Kenkyu (Study on Method For Grasping the Flow of Conversation in Two-Dimensional Chat System)”, Proceedings of the 66th National Convention of IPSJ, 2004, Vol. 4, pgs. 319 to 320

### DISCLOSURE OF INVENTION

### Problems to be Solved by the Invention

The two-dimensional chat system disclosed in Non-Patent Document 1 has a function (automatic placement function on a comment sentence) of, if an already placed comment sentence X is designated (or is designated to superpose it) and a comment sentence Y is input, automatically placing the comment sentence Y at a diagonal lower right position (indented position) of the comment sentence X. In a case where the function is used, the placed positions of comment sentences become closer to the right side of the display screen as a discussion develops. Therefore, the two-dimensional chat system implements a function (automatic extension function on a chat canvas) of automatically extending a chat canvas to the right side by a predetermined size if any one of comment sentences is placed in a predetermined range from the right end of the display screen.

However, in a case where a chat canvas is extended to some extent by the automatic extension function, a partial range of (or partial comment sentences on) the chat canvas is only displayed on the display screen. Therefore, it becomes difficult to grasp the entire situation of the chat canvas (what kind of discussion is being developed at which position). The purpose of the grasp of a point where a discussion is being actively performed can be served by providing a navigation screen displaying a placement relationship between or among comment sentences with simple forms/colors within reduced graphics in a chat canvas, for example. However, on such a navigation screen, the details of a discussion (details of a comment sentence) may not be grasped.

In order to refer to a discussion developed beyond the range displayed on the display screen at one time in a situation where a partial range of a chat canvas is only displayed, a scroll bar, for example, must be operated to move the display range of the chat canvas and thus refer to comment sentences. Particularly in order to follow multiple discussions simultaneously in a case where the discussions on multiple topics are being developed simultaneously and related comment sentences are expanding across a wide range of a chat canvas, the display range of the chat canvas must be changed frequently, and comment sentences of each of the topics must be referred. Such operations of changing the display range have imposed a large load on a user who is required to perform the operation of inputting comment sentences.

Accordingly, it is an object of the present invention to reduce a load on a user of operations for referring to comment sentences placed across a wide range of a chat canvas in a two-dimensional chat system and allow easy grasp of the placed positions and details.

### Means for Solving the Problems

A chat terminal device of the present invention includes a receiving module that receives chat data on a comment sentence input by a chat participant from a chat server and stores it in a memory, the chat data including at least text data on a comment sentence and positional information on an object (comment sentence object) for determining the comment sentence display position placed in a two-dimensional area (chat canvas), a position calculating module that projects a comment sentence object placed on a chat canvas to a screen viewed from a virtual camera in a three-dimensional virtual space where the chat canvas and virtual camera are placed and calculates the position of the comment sentence object on the screen, a display module that displays the comment sentence text data corresponding to the comment sentence object on the chat window on the basis of the calculated position of the comment sentence object on the screen, and a changing module that changes the position, line-of-sight direction or camera parameter of the virtual camera in the three-dimensional virtual space on the basis of an input from a user.

Preferably, the changing module relatively changes the gradient (canvas gradient) between the chat canvas and the line-of-sight direction of the virtual camera in the three-dimensional virtual space on the basis of an input from a user.

Preferably, the display module displays, on the chat window, the range of the chat canvas projected on the screen where the canvas gradient is 90 degrees.

Preferably, the display module indicates the dimension of a canvas gradient with any one of a gradient of a straight line, the dimension of graphics, the pitch of graphics and the contrast of graphics displayed on the chat window.

A chat system of the present invention includes at least one chat server and multiple chat terminal devices, wherein the chat server has a module that receives chat data on a comment sentence input by a chat participant from one of the multiple chat terminal devices and stores it in a memory, the chat data including at least text data on a comment sentence and positional information on an object (comment sentence object) for determining the comment sentence display position placed in a two-dimensional area (chat canvas) and a module that transmits the chat data to the multiple chat terminal device, and the chat terminal devices have a chat data receiving module that receives the chat data from the chat server and stores it in a memory, a position calculating module that projects a comment sentence object placed on the chat canvas to the screen viewed from the virtual camera in a three-dimensional virtual space where the chat canvas and virtual camera are placed and calculates the position of the comment sentence object on the screen, a display module that displays the comment sentence text data corresponding to the comment sentence object on the chat window on the basis of the calculated position of the comment sentence object on the screen, and a changing module that relatively changes the gradient (canvas gradient) between the chat canvas and the line-of-sight direction of the virtual camera in the three-dimensional virtual space on the basis of an input from a user.

A chat data display method of the invention includes a receiving step of receiving chat data on a comment sentence input by a chat participant from a chat server and storing it in a memory, the chat data including at least text data on a comment sentence and positional information on an object (comment sentence object) for determining the comment sentence display position placed in a two-dimensional area (chat canvas), a position calculating step of projecting a comment sentence object placed on the chat canvas to a screen viewed from a virtual camera in a three-dimensional virtual space where a chat canvas and a virtual camera are placed and calculating the position of the comment sentence object on the screen, a display step of displaying the comment sentence text data corresponding to the comment sentence object on the chat window on the basis of the calculated position of the comment sentence object on the screen, and a changing step of changing relatively the gradient between the chat canvas and the line-of-sight direction of the virtual camera in the three-dimensional virtual space on the basis of an input from a user.

A program (program product) of the present invention executes steps in the chat data display method of the present invention on a computer. The program (program product) of the present invention can be installed or loaded to a computer through a recording medium such as a CD-ROM, a magnetic disk, a semiconductor memory or over a communication network.

In the present specification, the module does not only mean physical means but also includes a case where a part or all of a function that the module has is implemented by software. A function that one module has may be implemented by two or more physical means, or functions of two or more modules may be implemented by one physical means.

### Advantages

According to the present invention, a load on a user of operations for referring to comment sentences placed across a wide range of a chat canvas in a two-dimensional chat system can be reduced, and easy grasp of the placed positions and details can be allowed.

### BEST MODES FOR CARRYING OUT THE INVENTION

With reference to drawings, embodiments of the present invention will be described below.

FIG. 1 is a block diagram showing a schematic configuration of a chat system 100 which is an embodiment of the present invention. As shown in FIG. 1, the chat system 100 includes a chat server 1 and multiple chat terminal devices 2a to 2d corresponding to users (chat participants) participating in a chat. The chat server 1 and the chat terminal devices 2a to 2d (which will be called “chat terminal device or terminals 2” collectively if the distinction among them is not required) are configured to be capable of communicating over a predetermined communication network N (which may be a LAN, the Internet, a dedicated line, a packet communication network or a combination thereof and may include both of wired and wireless ones). Notably, the numbers of the chat server 1 and chat terminal devices 2 can be changed in accordance with the design.

FIG. 2(a) is a block diagram showing a hardware configuration of the chat server 1. As shown in FIG. 2(a), the chat server 1 may be configured by a generic computer including hardware such as a CPU, a ROM, a RAM, an external storage device, a user interface, a display and a communication interface. Notably, the chat server 1 may be one configured by a single computer or one configured by multiple computers distributed over a network.

The chat server 1 includes a similar function configuration to that of a conventional chat server in principle. For example, it includes a chat data receiving module 10 that receives chat data and/or various requests from the chat terminal devices 2, a chat data management module 12 that stores and manages the received chat data in a chat data storage module 11 and a chat data transmitting module 13 that transmits chat data to the chat terminal devices 2 (refer to FIG. 2(b)). The function modules are implemented by executing predetermined programs stored in the ROM, RAM, external storage device or the like by the CPU.

However, the chat server 1 of this embodiment is different from a conventional chat server in that it can place a comment sentence object at an arbitrary position in a two-dimensional area (chat canvas) and it supports a two-dimensional chat system that displays comment sentence text data on a comment sentence display window (which will be called “chat window” hereinafter) on the basis of the position of a comment sentence object (that is, each of the modules can process chat data including at least comment sentence text data and positional information of a comment sentence object on the chat canvas).

FIG. 3(a) is a block diagram showing a hardware configuration of the chat terminal device 2. As shown in FIG. 3(a), the chat terminal device 2 may be configured by a generic computer including hardware such as a CPU, a ROM, a RAM, an external storage device, a user interface, a display and a communication interface. Notably, a mobile terminal may be used as the chat terminal device 2, as well as a general personal computer.

The chat terminal device 2 includes a similar function configuration to that of a conventional chat terminal device in principle. For example, it includes a chat data input module 20 that receives chat data including comment sentence text data and/or various requests from a user, a chat data transmitting module 21 that transmits input chat data and/or various requests to the chat server 1, a chat data receiving module 22 that receives chat data from the chat server 1, a chat data management module 24 that stores and manages the received chat data in a chat data storage module 23 and a chat data display module 25 that displays comment sentence text data on a chat window on the basis of the chat data (refer to FIG. 3(b)). The function modules are implemented by executing predetermined programs stored in the ROM, RAM, external storage device or the like by the CPU.

However, the chat terminal device 2 of this embodiment is different from a conventional chat terminal device in that it supports a two-dimensional chat system (that is, each of the modules can process chat data including at least comment sentence text data and positional information of a comment sentence object on the chat canvas), like the chat server 1.

Furthermore, the chat terminal device 2 of this embodiment is also different from a chat terminal device of a conventional two-dimensional chat system in that it includes a position calculating module 26 that, in a three-dimensional virtual space where the chat canvas and a virtual camera are placed, projects a comment sentence object placed on the chat canvas to the screen viewed from the virtual camera and calculates the position of the comment sentence object on the screen and a gradient changing module 27 that relatively changes, on the basis of the input from a user, the gradient (canvas gradient) between the chat canvas and the line-of-sight direction of the virtual camera in the three-dimensional virtual space and that the chat data display module 25 displays the comment sentence text data corresponding to the comment sentence object on the chat window on the basis of the calculated position of the comment sentence object on the screen.

With reference to flowcharts shown in FIGS. 4 to 6, a framework that displays comment sentence text data in the chat system 100 will be described. Notably, the order of steps (including partial steps to which reference numerals are not given) can be arbitrarily changed or the steps can be performed in parallel to the extent that does not contradict processing details.

### [Comment Sentence Input/Distribution/Reception Processing: FIG. 4]

If the chat terminal device 2 is active, the chat data input module 20 in the chat terminal device 2 awaits the input of chat data by a user (S100).

Here, as described above, chat data of this embodiment includes positional information of a comment sentence object on the chat canvas, in addition to comment sentence text data. The comment sentence object is an object for determining a comment sentence display position and may be a point object, for example. The positional information may be coordinate values in the chat canvas local coordinate system, for example.

Methods can be considered for inputting the coordinate values in a local coordinate system such as a method that directly inputs coordinate values from a keyboard and a method that uses a pointing device such as a mouse to directly designate and input a desired position on the chat canvas or chat window. Furthermore, for example, it may be configured that a keyboard is used first to input a comment sentence, whereby the comment sentence text data can be displayed at a predetermined position on a screen. Then, it may be configured that a pointing device such as a mouse is then used to drag the displayed comment sentence text data and drop it at a desired position, whereby the position of the comment sentence object can be designated on the basis of the dropped position.

If any chat data is input, the chat data transmitting module 21 transmits the chat data along with identification information of the user having input the chat data to the chat server 1 (S101).

In the chat server 1, if the chat data receiving module 10 receives the chat data from the chat terminal device 2 (S102), the chat data management module 12 stores the received chat data in the chat data storage module 11 (S103). FIG. 7 schematically shows a data structure of the chat data storage module 11. In this example, commenting user's identification information, comment sentence text data, positional information on the chat canvas are stored in connection with the chat data identification information.

Next, the chat data transmitting module 13 of the chat server 1 transmits (or distributes) the received and stored chat data to the chat terminal devices 2 (S104). Notably, for a user participating halfway through a chat, all of the chat data received and stored in the past for a predetermined period of time from the point in time of the participation of the chat data stored in the chat data storage module 11 is desirably transmitted to the corresponding chat terminal device 2.

In each of the chat terminal devices 2, if the chat data receiving module 22 receives chat data from the chat server 1 (S105), the chat data management module 24 stores the received chat data in the chat data storage module 23 (S106). The chat data storage module 23 may have a similar data structure to that of the chat data storage module 11 in principle.

### [Comment Sentence Display Processing]

The comment sentence display processing of this embodiment includes two of a display routine to be performed on the entire chat window if a canvas gradient is changed and a display routine to be performed on the received chat data if chat data is received. Those two comment sentence display routines will be described below.

### [Comment Sentence Display Routine Based On Change In Canvas Gradient: FIG. 5)

If the chat terminal device 2 is active, the gradient changing module 27 awaits the input of an instruction to change a canvas gradient by a user (S200).

Methods can be considered for inputting the change instruction, such as a method that directly inputs the value after a canvas gradient is changed and a method that operates a predetermined key (Such as the left and right keys of a cursor) to which functions of increasing/decreasing (+/−) a canvas gradient is assigned to increase/decrease the value. Notably, it may be configured that a predetermined constant canvas gradient (Such as 90 degrees) can be input with one predetermined key.

If an instruction to change a canvas gradient is input, the gradient changing module 27 changes the canvas gradient on the basis of the input instruction and stores it in a RAM, for example (S201).

Next, the position calculating module 26 determines, on the basis of the changed canvas gradient, the range (screen display range) of the chat canvas which can be projected on the screen of a virtual camera if the chat canvas is viewed from the virtual camera in a three-dimensional virtual space where the chat canvas and the virtual camera are placed (S202).

With reference to FIG. 8, the screen display range will be described.

In this embodiment, each coordinate system is defined provided that the chat canvas and the screen are rectangular and the angle of view, focal length and/or the like of the virtual camera are set for initially placing the chat canvas and screen as follows.

A coordinate system (x,y,z) in the three-dimensional virtual space is defined so that the position of the virtual camera is the origin O_{W} and the line-of-sight direction is the Z-axis.

A local coordinate system (p,q) on the chat canvas is defined so that the point of intersection with the Z-axis in a case where the chat canvas is placed perpendicularly to the Z-axis (line-of-sight direction of the virtual camera) is the origin O_{L} and a p-axis and a q-axis are in parallel with the top or bottom side and left or right side of the chat canvas. The chat canvas is initially placed so that, in a case where the chat canvas is placed perpendicularly to the Z-axis (line-of-sight direction of the virtual camera), the p-axis and q-axis can be parallel with the X-axis and Y-axis of the three-dimensional virtual space coordinate system.

A screen coordinate system (u,v) on the virtual camera is defined so that the focal point of the virtual camera is the origin O_{D} and a u-axis and a v-axis are in parallel with the top or bottom side and left or right side of the screen. The screen is initially placed so that the u-axis and v-axis can be in parallel with the X-axis and Y-axis of the three-dimensional virtual space coordinate system.

FIG. 8(a) shows the screen display range in a case with the initial placement (which will be called reference placement hereinafter).

As shown in FIG. 8(a), it is assumed that the chat canvas is sufficiently wide in the lateral direction (p-axis direction) and a partial area of the chat canvas is only projected on the screen in principle. This situation may occur in a case where a chat canvas which is wide in the lateral direction is used from the beginning of a chat or in a case where the chat canvas is extended in the lateral direction by the automatic extension function.

The canvas gradient is changed by horizontally rotating the chat canvas such that the incident angle of the line of sight of the virtual camera to the chat canvas can agree with the canvas gradient after the change, for example, by setting the right side P of the screen display range of the reference-placed chat canvas as the rotational axis in the Y-direction. FIG. 8(b) shows the screen display range in a case where the canvas gradient has been changed.

If the screen display range is determined in accordance with the canvas gradient, the position calculating module 26 refers to positional information on each comment sentence object stored in the chat data storage module 23 and extracts the comment sentence object to be placed on the screen display range of the chat canvas (S203).

Then, the position calculating module 26 calculates the coordinates in the three-dimensional virtual space on the basis of the positional information and changed canvas gradient for the extracted comment sentence object and calculates the position of the comment sentence object on the screen on the basis of the calculated coordinates in the three-dimensional virtual space in a case where it is projected (perspective-transformed) to the screen viewed from the virtual camera (S204).

The position of a comment sentence object on a screen may be calculated as follows, for example.

It is assumed that the focal length of the virtual camera is L, the x-coordinate of the right side P of the screen display range of the reference-placed chat canvas is m1, the positional information on a comment sentence object

A placed on the chat canvas, that is, the local coordinates are (p1,q1), and the distance between the reference-placed chat canvas and the virtual camera is z1 (refer to FIG. 9).

In this case, because the coordinates of the comment sentence object A on the reference-placed chat canvas in the three-dimensional virtual space are (p1,q1,z1), the coordinates (x2,y2,z2) of the comment sentence object A in the three-dimensional virtual space where the canvas gradient is θ can be calculated by:

x2=m1−(m1−p1)cos(90−θ)

y2=y1

z2=z1+(m1−q1)sin(90−θ)

The screen coordinates (u2,v2) of the comment sentence object A projected on the screen where the canvas gradient is θ can be calculated, on the basis of the way of thinking under the perspective transform, by:

u2=x2L/z2

v2=y2×L/z2

If the position of each of the extracted comment sentence objects on the screen is calculated, the chat data display module 25 next clears the display of the chat window and displays the comment sentence text data corresponding to the comment sentence object on the chat window on the basis of the calculated position of the comment sentence object on the screen (S205).

For example, if the scales of the chat window and the screen are matched, the coordinate values of the screen coordinate system (u,v) can be transformed to the coordinate values of the chat window coordinate system (a,b) by offsetting them properly. Therefore, by using the transformed coordinate values as the writing starting position, the comment sentence text data may be displayed. FIG. 10 schematically shows a display example of the chat window in a case where the canvas gradient has been changed.

### [Comment Sentence Display Routine On The Basis Of Reception Of Chat Data: FIG. 6]

If the chat data receiving module 22 in the chat terminal device 2 receives chat data, the position calculating module 26 determines whether the comment sentence object of the received chat data is included in the current screen display range or not (S300). If it is not included in the screen display range, the comment sentence display routine on the basis of the reception of chat data ends.

On the other hand, if it is included in the screen display range, the position calculating module 26 calculates the coordinates of the comment sentence object of the received chat data in the three-dimensional virtual space on the basis of the positional information and the current canvas gradient (such as the initial value 90 degrees if not changed) stored in the RAM, for example, and calculates the position of the comment sentence object projected to the screen viewed from the virtual camera on the basis of the calculated coordinates in the three-dimensional virtual space (S301).

Next, the chat data display module 25 displays, on the basis of the calculated position of the comment sentence object on the screen, on the chat window the comment sentence text data which corresponds to the comment sentence object of the received chat data (S302).

In this way, in this embodiment, the framework is adopted that determines the display position of each comment sentence on the chat window by projecting (perspective-transforming) (the comment sentence object on) the chat canvas placed in a three-dimensional virtual space to the screen of the virtual camera, and it is configured to allow a user to change the gradient (canvas gradient) between the line-of-sight direction of the virtual camera and the chat canvas.

In the configuration, as a result of that one or more discussions have been developed on the chat canvas, even in a case where a series of comment sentences relating to the discussions is placed over a wide range, a user may change the canvas gradient to control the range (screen display range) of the chat canvas which can be displayed on the chat window, and a series of comment sentences relating to the discussions can thus be displayed on the chat window simultaneously. Therefore, without operating a scroll bar, for example, to follow the discussions, the placed positions and details of the series of comment sentences can be easily grasped.

Because the display position of each comment sentence on the chat window is determined by projecting (perspective-transforming) a sloped chat canvas, the display positions of comment sentences have different pitches on the chat window in accordance with the distances between the virtual camera and (the comment sentence object on) the chat canvas. Therefore, for a comment sentence object group close to the virtual camera, the comment sentences can be displayed at a wide pitch that is easy to read, while, for a comment sentence object group far away from the virtual camera, more comment sentences are displayed, allowing the easy grasp of a broad overview.

### Variation Example

The present invention is applicable by changing in various manners, without limiting to the above embodiment.

For example, having described by assuming that the shapes of the chat canvas and screen are rectangular in the embodiment, the assumption is not required in the present invention, and any shape excluding rectangular shapes may be adopted as the shapes of the chat canvas and/or screen.

For example, in the embodiment, it is configured that the chat canvas is rotated by using the right side P of the screen display range in the three-dimensional virtual space as the rotational axis in the Y-axis direction in order to change the canvas gradient. However, the present invention is not limited to this configuration. For example, it can be configured to rotate by using the left side or center line of the screen display range as the rotational axis in the Y-axis direction, the upper side or lower side as the rotational axis in the X-axis direction or a straight line passing through a barycenter as the rotational axis in the Z-axis direction. Alternatively, it may be configured to allow a user to instruct an arbitrary rotational axis. Furthermore, it may be configured that, on the basis of a user's input, the gradient changing module 27 can change the position and/or line-of-sight direction of the virtual camera in a three-dimensional virtual space relatively or change a camera parameter (such as the angle of view and focal length). In those configurations, the screen display range can be controlled in a more flexible manner.

For example, in determining the display position of each comment sentence on the chat window, it may be configured that the a-axis coordinate values at the comment sentence display position on the chat window are only determined on the basis of u-axis coordinate values of the comment sentence object projected on the screen. In this case, it can be adopted that the values corresponding to the reference placement (more specifically, the coordinate values when the comment sentence object on the reference-placed chat canvas is projected on the screen) are used as the b-axis coordinate values at the comment sentence display position on the chat window. Notably, only the b-axis coordinate values may be determined on the basis of the v-axis coordinate values. In the configuration, the change in canvas gradient has an influence on one axial direction only on the chat window, and comment sentences in the other axial direction can be displayed without changing the pitch.

For example, it may be configured that the chat data display module 25 may display on a chat window the reference display range which corresponds to the screen display range of the reference-placed chat canvas. As the method for displaying the reference display range, methods can be adopted including a method that displays a translucent frame corresponding to the reference display range over the chat window, as shown in FIG. 11(a), for example. With the configuration, a user can easily grasp which comment sentence is to be displayed on the chat window in a case where a sloped chat canvas is returned to the reference placement.

Furthermore, it may be configured to allow a user to move the thus displayed reference display range on a chat window (refer to FIG. 11(b)). It is configured that, if an operation is performed for moving the reference display range and returning it to the reference place on the chat window, the chat canvas (or virtual camera) is moved such that the virtual camera can be at the reference position relative to the moved reference display range. Notably, instead of the movement of the reference display range on the chat window, it may be configured that the chat canvas is moved relatively (or the virtual camera is moved in parallel with the horizontal direction about the chat canvas).

Furthermore, it may be configured that the chat data display module 25 indicates the dimension of the canvas gradient on the chat window, using a numerical value or graphics. For example, as shown in FIG. 12(a), in a case where the chat canvas (or graphics imitating the outside shape thereof) is to be displayed on the chat window, it can be adopted to indicate the dimension of the canvas gradient with the gradients of the top and bottom sides of the chat canvas (or graphics imitating the outside shape). Alternatively, as shown in an example in FIG. 12(b), it may be configured that the dimension of a canvas gradient is indicated with any one of the size of graphics, the pitch of graphics, and the contrast of graphics. With those configurations, it becomes easier for a user to intuitively grasp the canvas gradient.

While the above embodiment has the configuration in which the chat terminal device 2 includes the position calculating module 26, it may be configured that the chat server 1 includes a function like the position calculating module 26 or other modules. In this case, it is configured that the chat terminal device 2 transmits information required for calculating a position (such as a canvas gradient input by a user) to the chat server 1 and that the chat server 1 manages the received information and so on for each user (each chat terminal device 2), defines a virtual camera for each user to perform similar processing to that in S202 to S205 and transmits the result to each chat terminal device 2.

While the embodiment has the configuration in which the display within the chat window is cleared once if a canvas gradient is changed, it may be configured, for example, that, for the comment sentence text data displayed on the chat window before the change, the display thereof may be moved from the display position before the change to the display position after the change on the screen without clearing the display.

Having omitted the description in the above embodiment, the two-dimensional chat system of the present invention may include an automatic placement function for each comment sentence and/or an automatic extension function for the chat canvas. If it includes the automatic placement function for each comment sentence, designation information on an already placed comment sentence object is input as the positional information on the comment sentence object in the chat terminal device 2, instead of the coordinate values of the comment sentence object. It may be configured, for example, that a function of rendering graphics or the like may be implemented in the chat terminal device 2 and that the rendering data of these graphics or the like is included in chat data.

### BRIEF DESCRIPTION OF DRAWINGS

FIG. 1 is a block diagram showing a schematic configuration of a chat system 100.

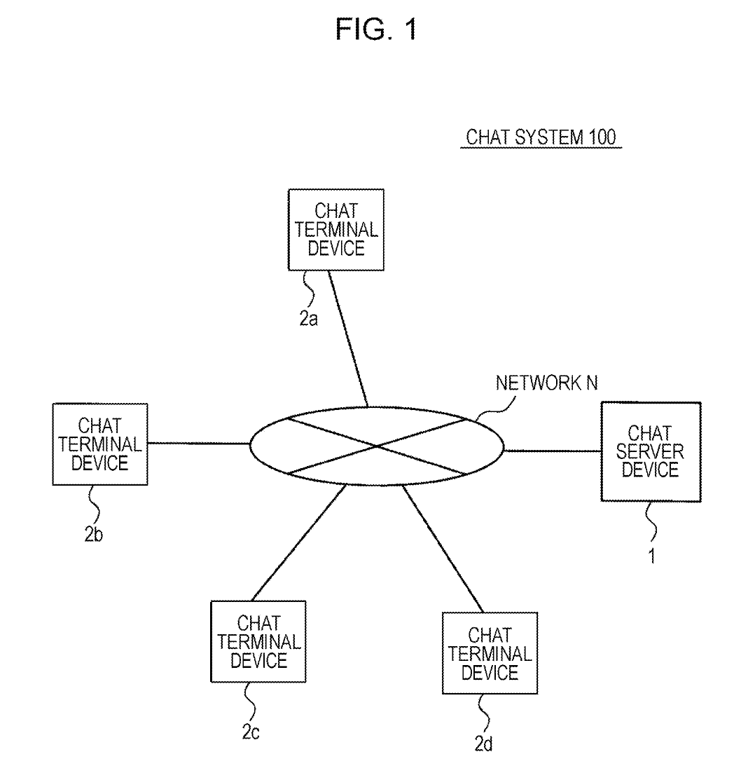

FIG. 2 is a block diagram showing a hardware and function configuration of a chat server 1.

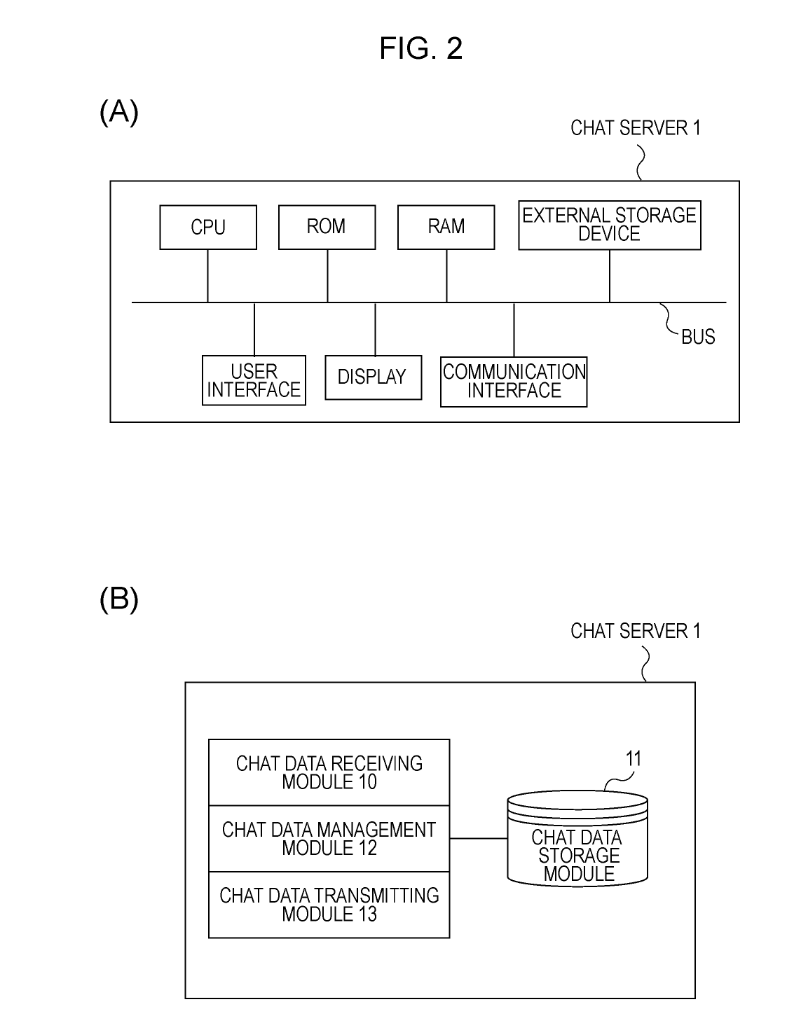

FIG. 3 is a block diagram showing a hardware and function configuration of a chat terminal device 2.

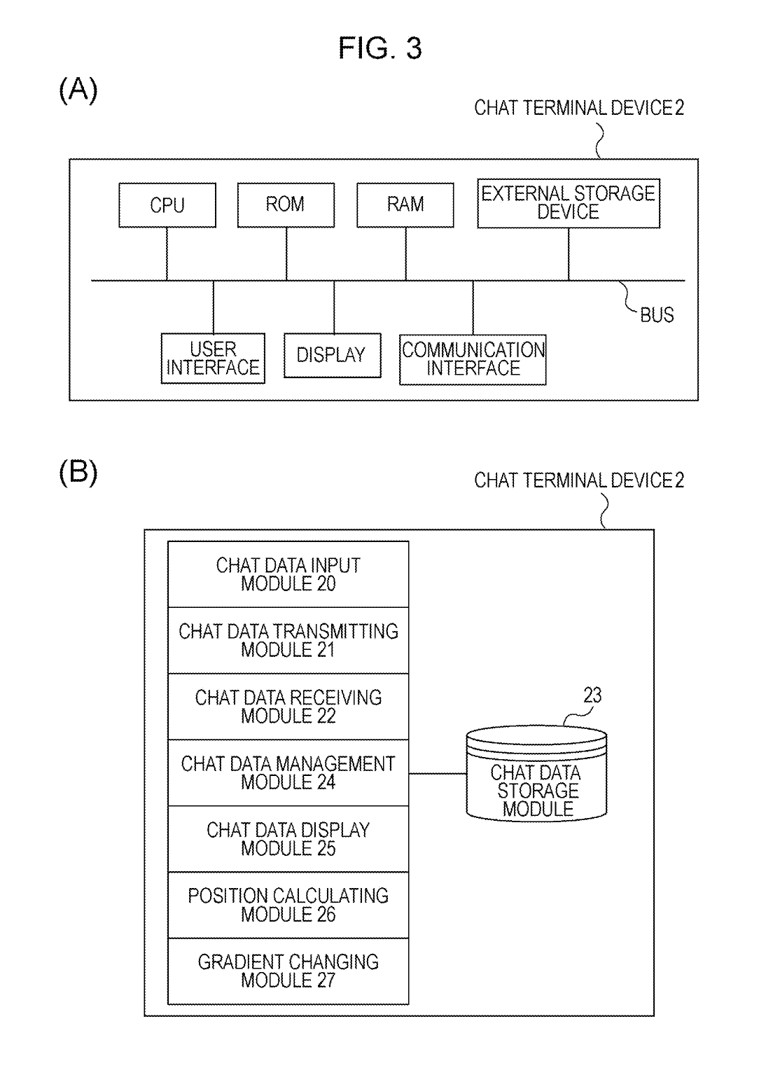

FIG. 4 is a flowchart for explaining comment sentence input/distribution/reception processing.

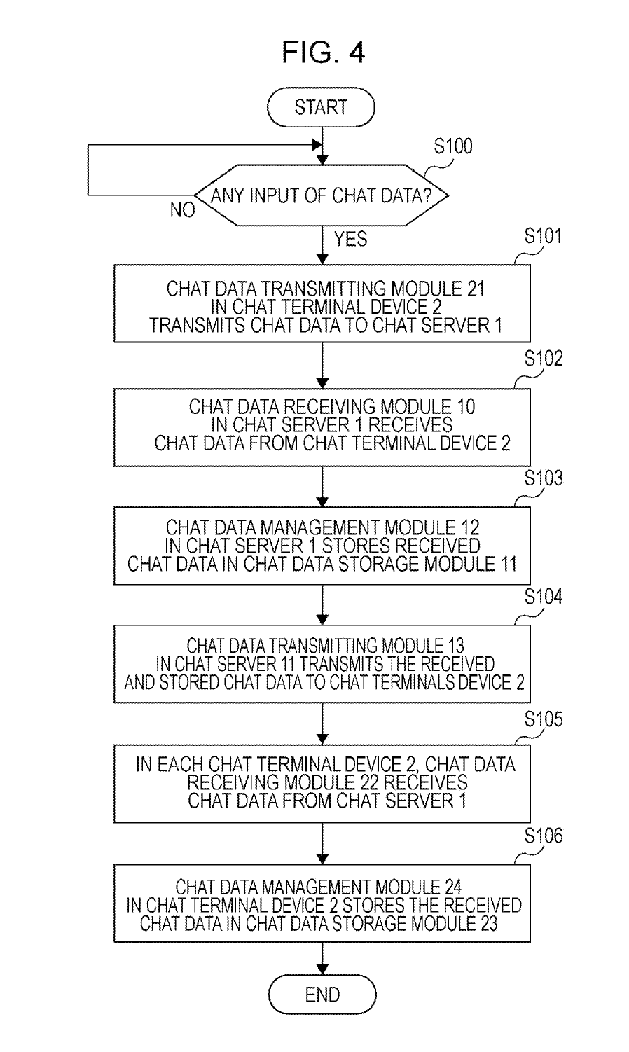

FIG. 5 is a flowchart for explaining comment sentence display routine based on a change in canvas gradient.

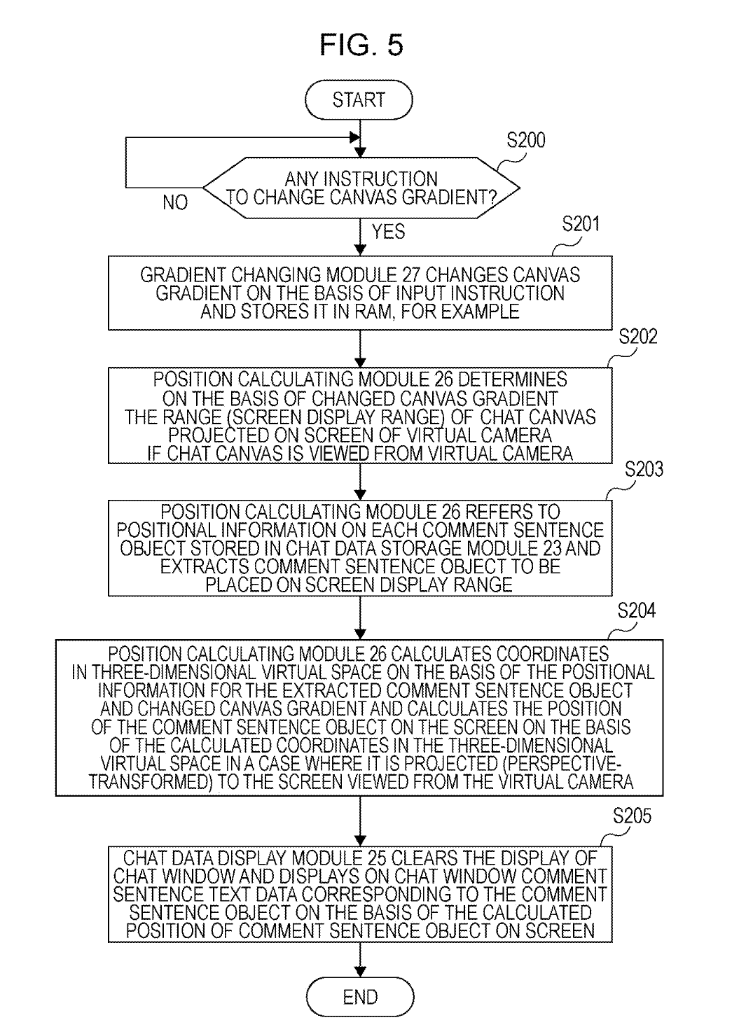

FIG. 6 is a flowchart for explaining comment sentence display routine based on chat data reception.

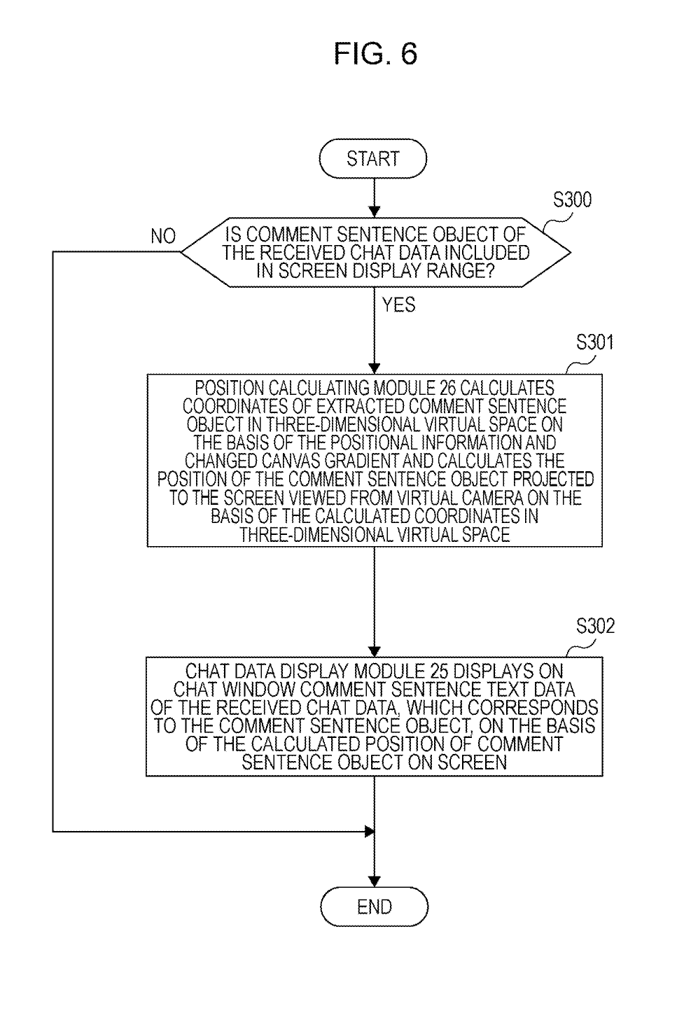

FIG. 7 is a diagram showing a data structure of a chat data storage module 11.

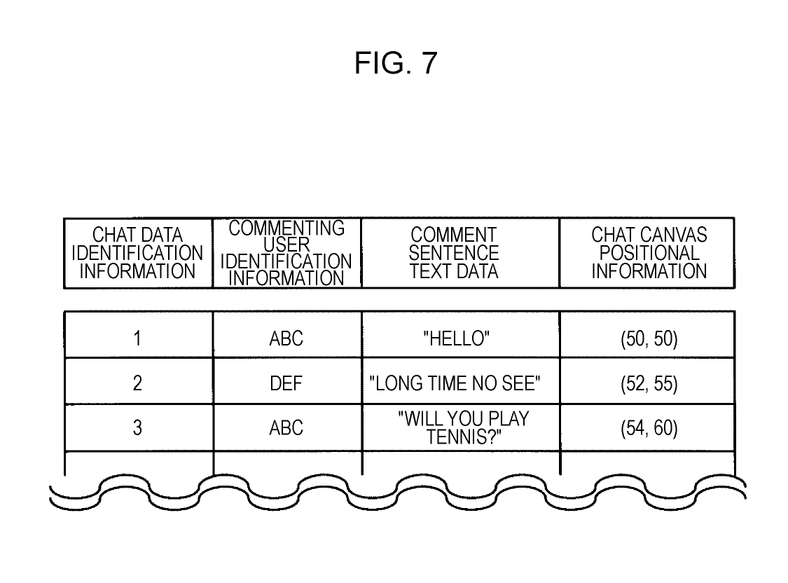

FIG. 8 is a diagram for explaining a screen display range.

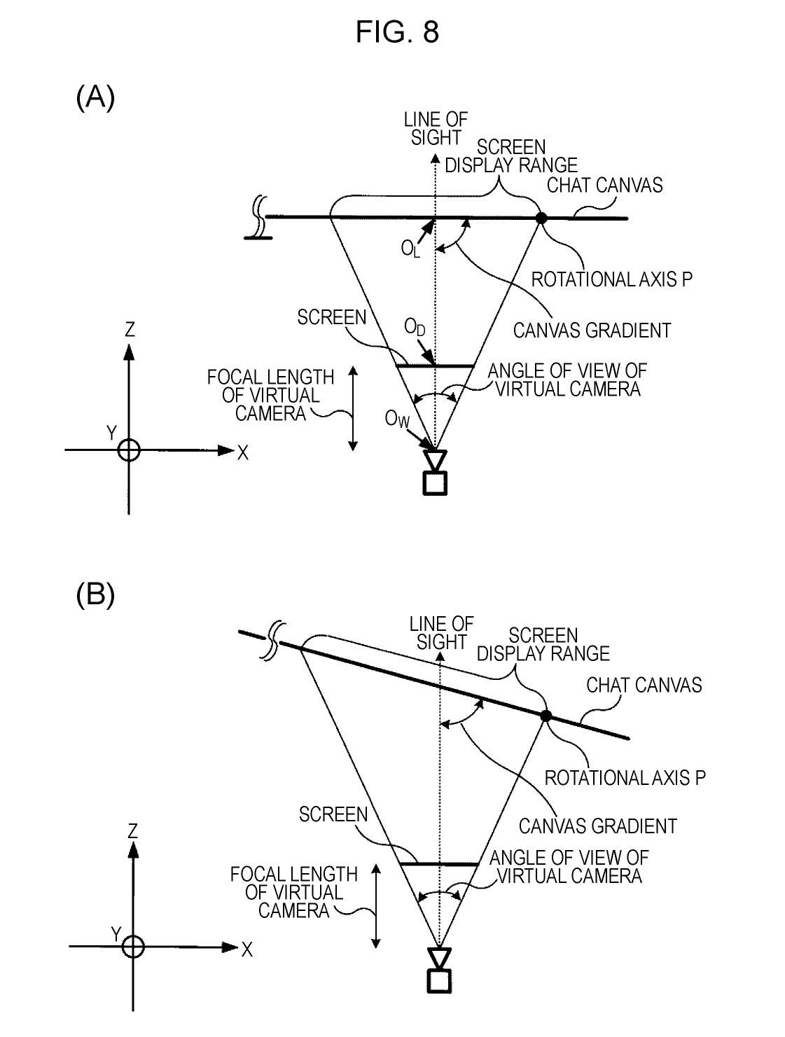

FIG. 9 is a diagram for explaining a method for calculating the position of a comment sentence object on a screen.

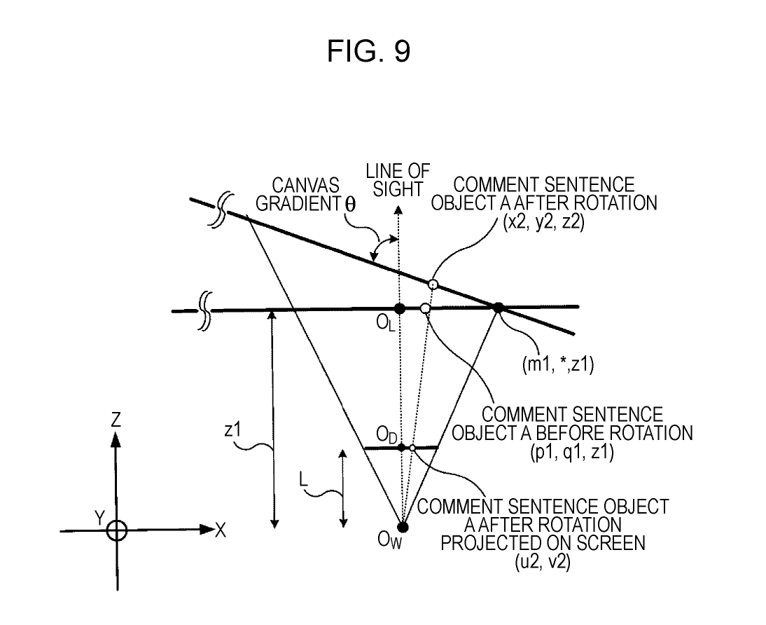

FIG. 10 is a diagram schematically showing a display example of a chat window in a case where a canvas gradient is changed.

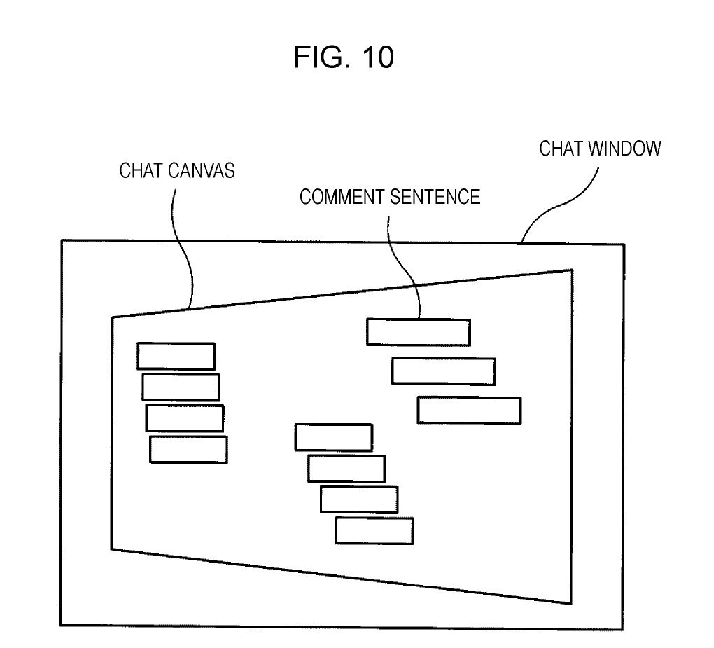

FIG. 11 is a diagram for explaining how a reference display range is displayed on a chat window.

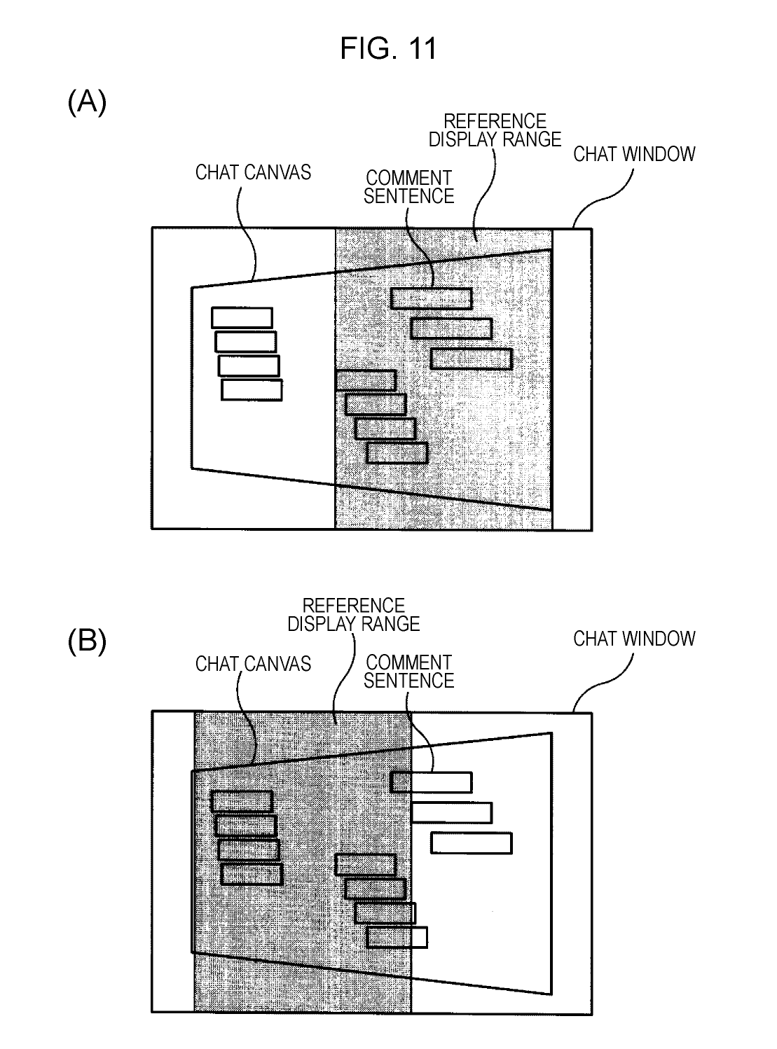

FIG. 12 is a diagram for explaining how a numerical value or graphics is used to indicate the dimension of a canvas gradient on a chat window.

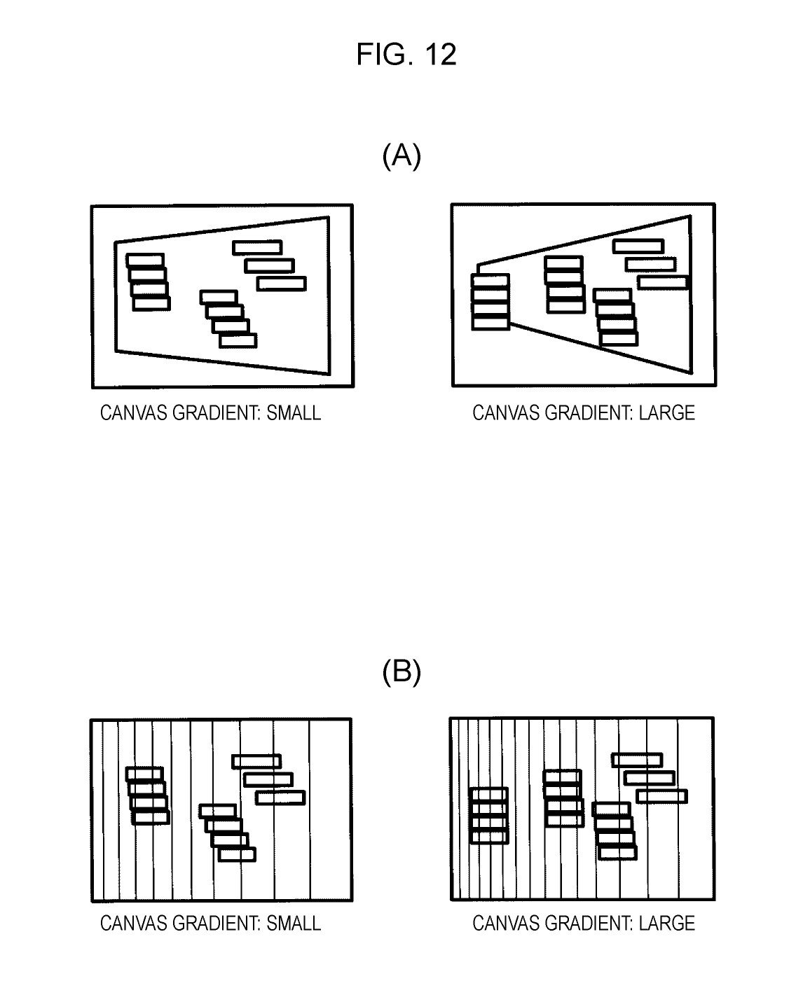

### REFERENCE NUMERALS

1 chat server
2 chat terminal device
10 chat data receiving module
11 chat data storage module
12 chat data management module
13 chat data transmitting module
20 chat data input module
21 chat data transmitting module
22 chat data receiving module
23 chat data storage module
24 chat data management module
25 chat data display module
26 position calculating module
27 gradient changing module
100 chat system

1. A chat terminal device comprising:
a receiving module that receives chat data on a comment sentence input by a chat participant from a chat server and stores it in a memory, the chat data including at least text data on a comment sentence and positional information on an object (which will be called “comment sentence object” hereinafter) for determining the comment sentence display position placed in a two-dimensional area (which will be called “chat canvas” hereinafter);
a position calculating module that projects a comment sentence object placed on a chat canvas to a screen viewed from a virtual camera in a three-dimensional virtual space where the chat canvas and virtual camera are placed and calculates the position of the comment sentence object on the screen;
a display module that determines the display position within the chat window of the comment sentence text data corresponding to the comment sentence object on the basis of the calculated position of the comment sentence object on the screen and displays the comment text data at the determined display position within the chat window; and
a changing module that changes the position, line-of-sight direction or camera parameter of the virtual camera in the three-dimensional virtual space on the basis of an input from a user.

2. The chat terminal device according to claim 1, wherein the changing module relatively changes the gradient (which will be called “canvas gradient”) between the chat canvas and the line-of-sight direction of the virtual camera in the three-dimensional virtual space on the basis of an input from a user.

3. The chat terminal device according to claim 2, wherein the display module displays, on the chat window, the range of the chat canvas projected on the screen where the canvas gradient is 90 degrees.

4. The chat terminal device according to claim 2, wherein the display module indicates the dimension of the canvas gradient with any one of a gradient of a straight line, the dimension of graphics, the pitch of graphics and the contrast of graphics displayed on the chat window.

5. A chat system comprising at least one chat server and multiple chat terminal devices, wherein the chat server has:
a module that receives chat data on a comment sentence input by a chat participant from one of the multiple chat terminal devices and stores it in a memory, the chat data including at least text data on a comment sentence and positional information on an object (which will be called “comment sentence object” hereinafter) for determining the comment sentence display position placed in a two-dimensional area (which will be called “chat canvas” hereinafter) and a module that transmits the chat data to the multiple chat terminal device; and
the chat terminal devices have:
a chat data receiving module that receives the chat data from the chat server and stores it in a memory;
a position calculating module that projects a comment sentence object placed on the chat canvas to the screen viewed from the virtual camera in a three-dimensional virtual space where the chat canvas and virtual camera are placed and calculates the position of the comment sentence object on the screen;
a display module that determines the display position within the chat window of the comment sentence text data corresponding to the comment sentence object on the basis of the calculated position of the comment sentence object on the screen and displays the comment text data at the determined display position within the chat window; and
a changing module that changes the position, line-of-sight direction or camera parameter of the virtual camera in the three-dimensional virtual space on the basis of an input from a user.

6. A chat data display method comprising:
a receiving step of receiving chat data on a comment sentence input by a chat participant from a chat server and storing it in a memory, the chat data including at least text data on a comment sentence and positional information on an object (which will be called “comment sentence object” hereinafter) for determining the comment sentence display position placed in a two-dimensional area (which will be called “chat canvas” hereinafter);
a position calculating step of projecting a comment sentence object placed on the chat canvas to a screen viewed from a virtual camera in a three-dimensional virtual space where a chat canvas and a virtual camera are placed and calculating the position of the comment sentence object on the screen;
a display step of determining the display position within the chat window of the comment sentence text data corresponding to the comment sentence object on the basis of the calculated position of the comment sentence object on the screen and displaying the comment text data at the determined display position within the chat window; and
a changing step of changing the position, line-of-sight direction or camera parameter of the virtual camera in the three-dimensional virtual space on the basis of an input from a user.

7. An information processing program for causing a computer to execute the chat data display method according to claim 6.
